(19) United States
(12) Patent Application Publication
(10) Pub. No.: US 2006/0143671 A1
(43) Pub. Date: Jun. 29, 2006

(54) Digital process analysis and control camera system

(76) Inventors: John Edwards Ens, British Columbia (CA); Edwin Michael Gyde Heaven, British Columbia (CA); Kari Kristian Hilden, British Columbia (CA); Ian Hinde, British Columbia (CA); Tibor Kallo, British Columbia (CA); Patrick Koropatnick, British Columbia (CA)

Correspondence Address: KOLISCH HARTWELL, P.C., 200 PACIFIC BUILDING, 520 SW YAMHILL STREET, PORTLAND, OR, 97204, US

(21) Appl. No.: 11/021,559

(22) Filed: Dec. 23, 2004

(51) Int. Cl. H04N 7/173

(52) U.S. Cl. 725/105

(57) ABSTRACT

Many continuous processes, such as paper manufacturing, use analog camera systems to capture break events and use the video information to diagnose runnability problems. These systems trigger off a break signal on the machine and synchronize all videos to the same point on the process using the machine speed. The present invention provides a new approach to use real-time information from digital cameras to perform image analysis in real time and execute specific control functions normally performed by operators. A reference image is defined as the control objective function and each frame from the cameras is compared to the reference image. Deviations from the reference image that exceed a defined deadband (the threshold) are output to the control system to take corrective action. The applications of the disclosed approach include dynamic draw control, trim control, tension control, release angle control, creping blade control with control signals determined from a two-dimensional camera image.

### FIELD OF THE INVENTION

This invention relates to generally to camera systems for monitoring manufacturing processes, and in particular to a high speed digital camera system that employs real-time information to perform image analysis and execute specific process control functions.

### BACKGROUND OF THE INVENTION

Many continuous processes, such as paper manufacturing, have used analog camera systems to capture break events, and use the video information to diagnose runnability problems. These systems trigger off a break signal on the machine and synchronize all videos to the same point on the process using the machine speed. In this manner, production problems can be readily observed, diagnoses and fixed.

Examples of prior developments in this field are disclosed in the following US Patents:

U.S. Pat. No. 5,717,456 Robert J. Rudt, et. al.

U.S. Pat. No. 5,821,990 Robert J. Rudt, et. al., and

U.S. Pat. No. 6,211,905 Robert J. Rudt, et. al.

These patents teach the collection of video from the papermaking processes and apply it to the diagnosis of papermaking problems after a break occurs. It is possible to trigger off a given deviation sensor (break detector, hole detector, etc.) but there is no mention of real time image-to-reference processing using the video information itself or active control based on this information.

U.S. Pat. No. 6,463,170 Juha Toivonen, et. al. teaches the use of the cameras themselves to determine the alarm condition. The algorithm described compares sequential images to a reference level considered normal and alarms a condition deviating from the reference level considered normal. It is possible to focus the analysis on a particular region (Region of Interest) of the video and alarm if one or more images from multiple cameras exceeds a given reference. Reference images can be updated periodically, continually or based on a user-defined image. The only output from the system is an alarm when the image exceeds a given threshold. The algorithms that detect the deviation are not described but performed in hardware using a DSP board.

U.S. Pat. No. 6,615,511 Thomas Augscheller, et al. describes the use of a various detectors to view the sheet as it is passed through an impingement dryer. One of the detectors disclosed is a sheet image using a camera.

U.S. Pat. No. 6,629,397 Heinz Focke, et. Al. disclose the use of cameras to monitor production of a cigarette machine to diagnose production problems, identify maintenance issues and exchanges data collected with other computers.

A typical implementation of a conventional event capturing system 2 is illustrated schematically in FIG. 1 using cameras 3 communicating with computers running software to control the system. While FIG. 1 shows a simplified overall architecture, the illustrated event capturing system 2 demonstrates the typical distributed architecture which relies on three types of processes:
Multiple Capture Module processes,
One Server process, and
Several Client processes.

The Capture Module processes and the Client processes usually run on separate computers, often personal computers (PCs). In FIG. 1, computers 4 with capture module hardware and software perform the capture module processes while client computers 6 run software that provides the client processes. The Server process usually runs on one of the client PCs, however, FIG. 1 shows a dedicated server computer 8 which is an alternative arrangement. Each computer is equipped with a network card to allow the computers to communicate with each other over a network, preferably using TCP/IP. For a small portable system with only one or two cameras, all the processes can run on one computer.

Up to thirty-two cameras 3 are connectable to capture module computers 4. Usually one camera 3 communicates with one piece of capture module hardware, although up to four cameras can be connected to the hardware. The capture module hardware and software act to compress the images from the cameras and also perform real-time processing. The capture module hardware and software is controlled by the server 8. Any number of client computers 6 can connect to the server. These clients run the user interface.

Conventional event capturing systems use an ever expanding range of analog cameras. The cameras currently supported are shown in the following table:

| Manu- | | | | Images | | Remote |
|---|---|---|---|---|---|---|
| facturer | Model | Standard | Color | Per Sec | Image Size | Control |
| Pulnix | TM-200NIR | EIA | Monochrome | 60 | 640 × 240 | No |
| Pulnix | TM-300NIR | CCIR | Monochrome | 50 | 760 × 285 | No |
| Pulnix | TMC-7DSP | NTSC | Color | 60 | 640 × 240 | No |
| Pulnix | TMC-6DSP | PAL | Color | 50 | 760 × 285 | No |
| JAI | CV-M30 | Double | Monochrome | 120 | 640 × 240 | No |
| | | Speed | | | | |
| Sony | FCB-EX45M | EIA | Monochrome | 60 | 640 × 240 | Yes |
| Sony | FCB-EX45MCE | CCIR | Monochrome | 50 | 760 × 285 | Yes |
| Sony | FCB-EX480B | NTSC | Color | 60 | 640 × 240 | Yes |
| Sony | FCB-EX480BP | PAL | Color | 50 | 760 × 285 | Yes |
| FLIR | A20V | NTSC/PAL | Color | 60/50 | 160 × 120 | Yes |

In particular, the Sony® cameras permit remote control of zoom, focus, aperture and all other camera settings.

The cameras 3 are preferably connected to the capture module hardware via co-axial cable or by fiber with AM transceivers.

FIG. 2 shows a block diagram of the capture module software and hardware installed within capture module computers 4. Images from cameras 3 are fed to the capture module computer 4 where the images are processed by frame grabbing hardware 10. By way of example, conventional event capturing systems generally support the frame grabbers shown in the table below:

| Manufacturer | Model | Camera Type |
|---|---|---|
| Integral Technologies ® | FlashBus MV | EIA, CCIR, NTSC, PAL |
| Integral Technologies ® | FlashBus Spectrim | EIA, CCIR, NTSC, PAL |
| Integral Technologies ® | FlashBus MX-132 | Double Speed, EIA, |
| | | CCIR |
| Integral Technologies ® | FlashBus MX-332 | RGB Color |

The interface to each frame grabber is handled by a separate dynamic link library (DLL) module, so adapting to new frame grabber hardware does not require any changes to the main software.

The frame grabber driver continuously writes the images to a rotating buffer 12 of uncompressed images. The Channel Manager 14, which runs on a high priority thread, monitors the rotating buffer 12 and dispenses image pointers to the following other functions which run as separate threads:

Compression,

Real-time analysis

In the compression thread 16, the images are compressed individually generally using JPEG compression. Typcially, the software uses the Intel JPEG compression library (IJL) which is optimized for the SSE instruction set on the Pentium 4 processor. The compressed images are written to a rotating storage buffer 18 on the hard drive, as well as a rotating storage buffer 20 in RAM. The rotating storage buffer 18 on the hard drive can be very large.

When a video download is requested, the rotating buffer 18 in the hard drive is simply renamed as a video file and a new rotating buffer is created on the hard drive. Therefore a video download is almost instantaneous.

The rotating storage buffer 20 in RAM is used for storing partial videos. When a partial video download is requested by the server 8, a separate thread is created which writes compressed images from RAM to a new video file on the hard drive. Meanwhile, the compression thread continues seamlessly so that no images are lost.

The real-time analysis thread 24 runs on a separate thread which continuously requests image pointers from the Channel Manager. The algorithm was designed to find changes in the camera images. Each image is compared to a reference image to determine if any changes have occurred. The sensitivity as well as the required size of changes can be adjusted.

When a video is downloaded, the real-time analysis information is saved in the video as greyscale information. When the video is opened, a one dimensional graph is produced, which visually shows changes along the entire length of the video file.

As best shown in FIG. 3, in conventional systems, it is possible for the analog video from cameras 3 to also be sent to a quad analog multiplexer 28 which takes four raw camera feeds and multiplexes them onto one analog channel where each camera can be viewed in one quadrant of a monitor 30 in real time. Multiple sets of four cameras 3 can communicate with an associated multiplexer which in turn displays the processed images on an associated monitor. Each monitor view can be switched from a single, full screen camera view to quad views by the operator to provide the operator with improved visibility of the process being monitored. A block diagram of this implementation is shown in FIG. 3.

Videos are stored in a proprietary file format. Each camera produces its own video file. An event consists of one or more video camera files. This file format contains the compressed JPEG images, but also contains ancillary data such as:
Data about when and where the video was recorded,
Greyscale information which gives a visual graph of changes in the video,
Region of Interest (ROI) mask,
Reference images from the real-time analysis,
Machine speed information for synchronization of different camera views, and
User added annotations for any image in the video file.

The file format is based on tagged fields so that it can easily be expanded when more data is desired in the video file. Videos are initially stored in rotating storage on the hard drives of the capture modules. When the hard drive is full, older videos are automatically deleted. Videos can also be moved to permanent storage on the host PC.

In conventional systems, the video information is use to generate visual or audible alarms as indicated by arrow 9 in FIG. 1 that are monitored by operators. There may be outputs to information systems on the type/location of the defect/event or to PLCs/DCS systems, but not usually to perform control on the machine.

### SUMMARY OF THE INVENTION

The present invention provides a new approach to use real-time information from digital cameras to perform image analysis in real time and execute specific control functions normally performed by human operators. A reference image is defined as the control objective function and each frame from the cameras is compared to the reference image. Deviations from the reference image that exceed a defined deadband (the threshold) are output to the control system to take corrective action. The applications of the inventive system include dynamic draw control, trim control, tension control, release angle control, creping blade control with control signals determined from a two-dimensional camera image.

Accordingly, the present invention provides a digital vision control system for monitoring and controlling a manufacturing process of a web product occurring on manufacturing equipment comprising:

at least one sensor positioned at a predetermined location adjacent the manufacturing equipment to acquire real time digital images of the web product and the equipment;

a broadband communication network to transfer the real time digital images from the at least one sensor to an analysis system;

said analysis system processing the real time digital images and generating control outputs for communication to the manufacturing equipment by the broadband communication network.

In a further aspect, the present invention provides a method for monitoring and controlling a manufacturing process of a web product occurring on manufacturing equipment comprising:

acquiring real time digital images of the web product and the equipment using at least one sensor positioned at a pre-:determined location adjacent the manufacturing equipment;

transferring the real time digital images from the at least one sensor via a broadband communication network to an analysis system;

processing the real time digital images using the analysis system and generating control outputs for communication to the manufacturing equipment by the broadband communication network.

The system of the present invention moves the process of digitizing of the acquired images as close as possible to the sensor—or has the sensor itself perform the digitization—and has each sensor stream the video information as it is acquired over a high-bandwidth network communication system for analysis by computer or human machine interface (HMI) systems.

### BRIEF DESCRIPTION OF THE DRAWINGS

Aspects of the present invention are illustrated, merely by way of example, in the accompanying drawings in which:

FIG. 1 is a schematic view of a prior art event capturing system showing a simplified overall architecture;

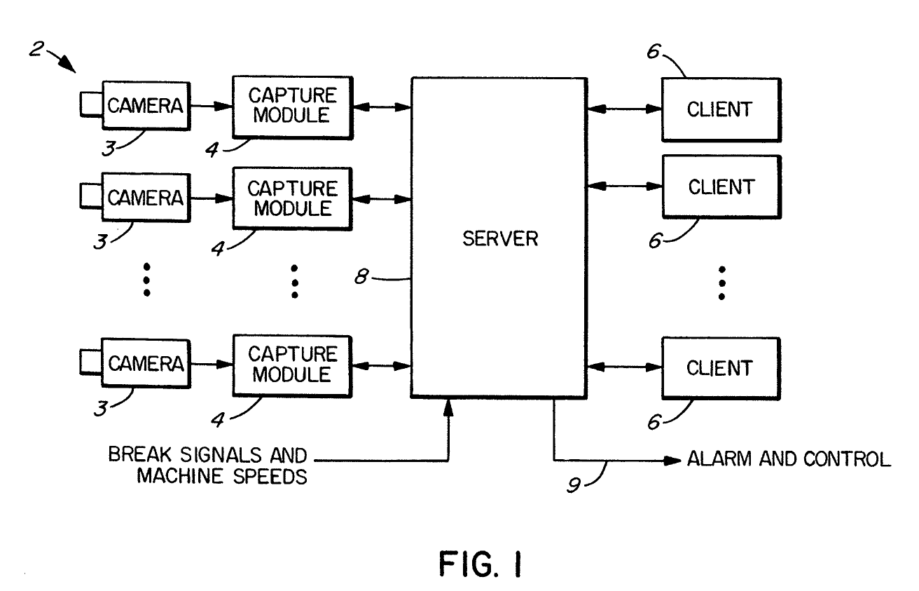

FIG. 2 is a block diagram showing the capture module processes according to prior art event capturing systems;

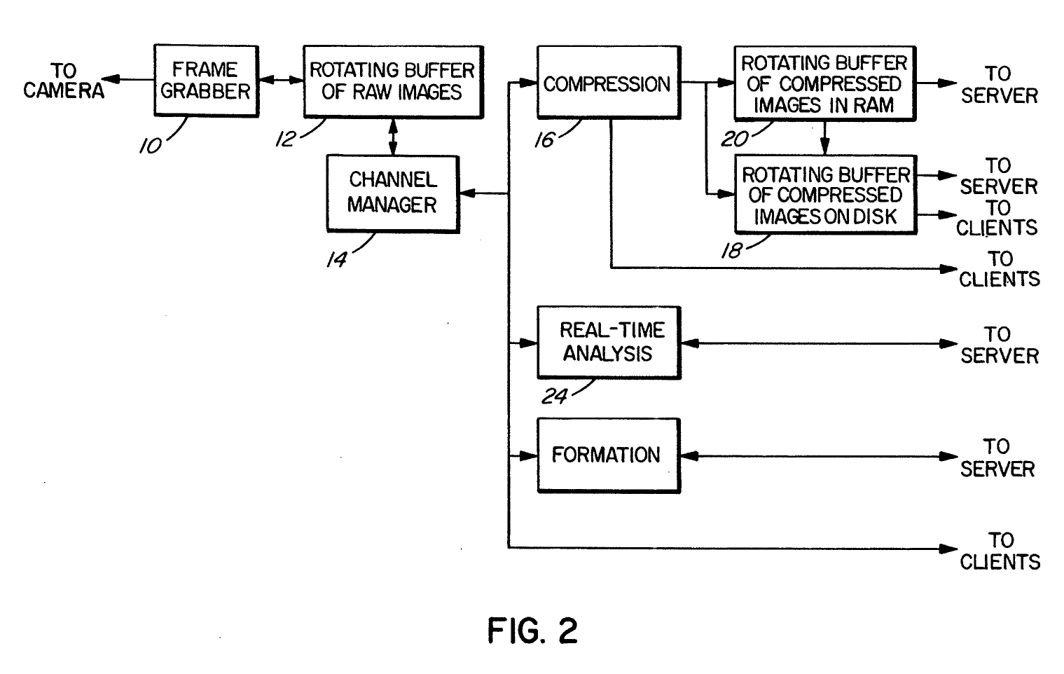

FIG. 3 is a block diagram of a real time display arrangement for prior art event capturing systems; and

FIG. 4 is a block diagram showing the digital camera analysis and control system according to the present invention.

### DESCRIPTION OF THE PREFERRED EMBODIMENTS

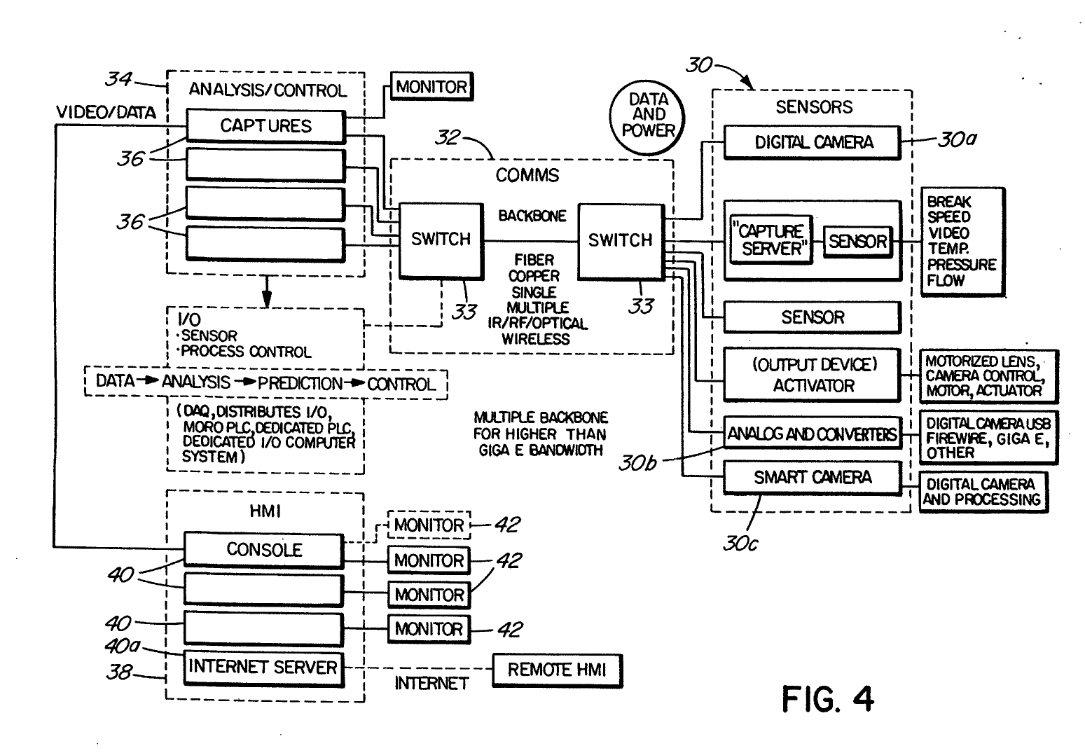

Referring to FIG. 4, there is shown a block diagram of the control system according to a preferred embodiment of the present invention. The system is employed to monitor and control a manufacturing process involving formation of a continuous web or sheet product on manufacturing equipment. Processes of this type include papermaking, pulp generation, hot and cold rolled steel production, plastic manufacturing or the production of fabric (woven or non-woven) material.

The system of the present invention relies on at least one sensor positioned at a pre-determined location adjacent the manufacturing equipment to acquire real time digital images of the web or sheet product under manufacture and the manufacturing equipment. Preferably, a plurality of sensors are positioned at various locations adjacent the manufacturing equipment where monitoring of the web under manufacture and the manufacturing equipment is necessary to control the manufacturing process. FIG. 4 shows a general bank of “sensors” 30 which may be digital cameras 30a, analog cameras with embedded digital converters 30b, smart cameras 30c, or other traditional sensors associated with a given manufacturing process. The sensors collect digital images and information and stream this data across a broadband network 32 to transfer the images to an analysis system 34. A smart cameras is a unit that not only acquires an image, but is also capable of processing the image into a digital packet ready for transmission, and may also be able to perform analysis on the image to compare it to a known pattern and alarm changes. Specific examples of digital info that may be streamed other than images include deviation image of the web under manufacture, alarm details, and the results of any analysis that may have been performed by a smart camera. The sensors of the present system become smart digital sensors streaming the high-resolution images and other digital data as they are acquired by the sensors.

Digitization at the sensors means that the broadband network 32 can be in the form of a multicast digital communication backbone between the sensors 30 and the analysis system 34, thus dramatically increasing the data rates possible. An example of a suitable communication network is one operating over the Gigabit Ethernet protocol, however, the present invention is not restricted to any one standard. Use of a digital communication standard also means a significant extension to the distances possible between the sensors 30 and the analysis system 30 by use of fiber optic cable or digital repeaters.

It will be noted that conventional digital cameras in use today for batch video collection generally use CameraLink or FireWire (or its successor IEEE 1394b) to transmit the video information after it is collected. While CameraLink and FireWire are capable of real time transmission of each frame as it is acquired, this approach is not generally used or available in many cameras. In addition, CameraLink is not capable of multicast and FireWire, while capable in theory of multicast, most FireWire drivers do not support multicast transmission of the video information.

The broadband communication network can transmit its data over various media. For example, transmission media such as fiber optic, category 5 cabling, copper wire, radio frequency (RF), infrared (IR), and wireless or any single/multiple conduction communication trunk can be used to transfer data.

With the present invention, it is possible for each camera to stream its video information in digital format to multiple locations as the information is transmitted using a multicast network protocol such as Gigabit Ethernet.

Preferably, Gigabit Ethernet switches 33 are used to communicate over the backbone so that the full bandwidth of the network is available at each port if required. This arrangement means that the throughput from a camera in burst mode is limited only by the speed of the camera and the full throughput of the switch.

The Gigabit Ethernet backbone allows the elimination of all analog components (cameras, coax) and replicates all the functionality in digital format. This has the following advantages:
Fast video streaming transmission rates (higher than the 50/60 or 120 frames/second possible with today's analog cameras)
Higher resolution images
Less Noise
Compressed or raw video can be streamed
Higher data rates in stream mode from any one camera
Control to the cameras can be over the same two-way network
Power to the cameras or sensing elements can be delivered via the communication network
Sensors are not restricted to cameras—they can be any sensing element that uses the defined protocol (Gigabit Ethernet or other), including:
   Digital Matrix (CCD) cameras
   Digital Line-scan cameras
   Sensing elements (vibration accelerometers, pressure transducers, etc.)
   Thermal cameras
   Conventional analog cameras with an embedded digital conversion module

Digital images transmitted by sensors 30 over broadband communication network 32 are received by analysis system 34 which acts to process the real time digital images and generate control outputs for communication to the manufacturing equipment by the same broadband communication network. For example, analysis system 34 receives the streaming video information over the multicast network, performs analysis on the real-time information and makes control or operating decisions based on this analysis. The analysis system 34 is preferably located remote from the sensors 30 and operates in a controlled environment. The analysis system comprises one or more computers 36 running appropriate software to analyze the captured digital images. Computers 36 ate preferably connected to broadband communication network 32 via a switch 33.

The analysis system may be restricted to only analysis and control or may also include a human machine interface (HMI) 38 for displaying control and alarm information to an operator or to permit operator interaction with the analysis system. The human machine interface 38 is created on additional computers 40 running appropriate software to display video and present an appropriate interface on attached displays 42 for operator interaction with the analysis system. Human machine interface computers 40 provide various data base utilities and editing/review functions. Computers 40 can be local or web based and handle the compressed or uncompressed images from the multicast stream to display:
Real-time high-resolution images
The results of the analysis in real time

For web based access, an Internet server computer 40a is provided to permit remote communication over the internet.

The analysis system 34 provides the following analysis and control functions which are significantly more advanced than the analysis and event capture functions provided in prior art systems.
1. Comparing the current image from any camera to a taught “reference” image or pattern and detecting changes in the image (using grayscale changes (which is available in prior art systems), digital comparison algorithms, digital enhancement techniques (edge filters), etc.)
2. Examining selected regions of the image for changes and alarming those changes that occur in this region (which is available in prior art systems)
3. Following the trajectory of an object on the image as it changes over time—providing this trajectory as a trend to the operator and as a control feedback signal to a control system to maintain the object within certain limits (for speed control, draw control, etc.)
4. Detecting changes in a region anchored to the edge of an object (such as the edge of sheet) to detect and alarm cracks, defects, etc.
5. To allow steering control of an object within the camera view
6. To highlight an object in a particular camera view and find the same object on all the other (upstream) camera views
7. To regulate trimming devices, water sprays, etc. based on a desired pattern
8. To alarm and classify objects seen by the cameras
9. To control the visual pattern of an object seen by the camera by manipulating various control parameters that affects the pattern (chemicals such as retention aids, dyes, etc.).

Functions 4 to 9 above are unique to the system of the present invention and are not available in prior art video event capturing systems.

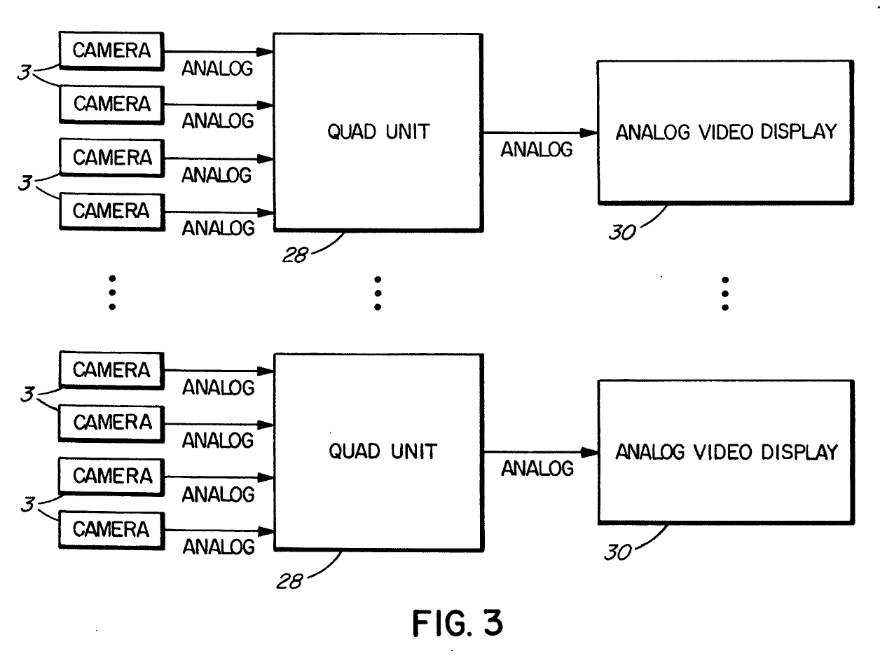

As explained above in relation to FIG. 3, in prior art video event capturing systems, real-time video information is displayed to operators in an entirely analog system. With the digital implementation of the present invention, it is possible to replace the analog system of the prior art entirely with a digitized signal and appropriate software.

By way of example, two preferred configurations will be described:
If bandwidth between analysis system computers 36 and HMI computers 40 is limited, then HMI computers can show compressed video from any camera. Multiple cameras can be shown simultaneously as allowed by bandwidth.
HMI computers can show compressed or uncompressed images from any camera. Multiple cameras can be shown simultaneously but at smaller resolution.

Images are compressed by the analysis system computers 36 and sent out across the digital network. Client HMI computers can access compressed video from any camera. The images are decompressed at the client computer and then displayed. This can be done over a 100 Mbps network or over the Internet.

In addition to compressing images, the analysis system computers 36 also decimate uncompressed images to ¼ and ⅛ resolution and resend the resulting images over the network. To save bandwidth, uncompressed images are streamed to all HMI computers 38 and analysis system computers 36 that are consuming images from that camera. Usually a Gigabit network is used. This means that the traditional quad display of four analog camera images can be completely replaced with a digital system where the quad or octet images are created by the analysis system computers 36 in digital form.

The analysis system includes means for remotely setting image acquisition and image stream rates for the at least one sensor, such that the loading of the broadband communication network is dynamically allocatable to any one of the at least one sensor.

Although the present invention has been described in some detail by way of example for purpose of clarity and understanding, it will be apparent that certain changes and modifications may be practised within the scope of the appended claims.

We claim:

1. A digital vision control system for monitoring and controlling a manufacturing process of a web product occurring on manufacturing equipment comprising:
at least one sensor positioned at a pre-determined location adjacent the manufacturing equipment to acquire real time digital images of the web product and the equipment;
a broadband communication network to transfer the real time digital images from the at least one sensor to an analysis system;
said analysis system processing the real time digital images and generating control outputs for communication to the manufacturing equipment by the broadband communication network.

2. The system of claim 1 in which the at least one sensor comprises a plurality of sensors positioned at pre-determined locations adjacent the manufacturing equipment.

3. The system of claim 1 in which the at least one sensor comprises an analog camera with embedded digital converter.

4. The system of claim 1 in which the at least one sensor comprises a digital matrix (CCD) camera.

5. The system of claim 1 in which the at least one sensor comprises a digital line scan camera.

6. The system of claim 1 in which the broadband communication network is a Gigabit ethernet network.

7. The system of claim 1 in which the at least one sensor includes a communication unit to stream digital image data using the Gigabit ethernet protocol.

8. The system of claim 1 in which the broadband communication network transfers data using a multicast protocol capable of streaming.

9. The system of claim 1 in which the broadband communication network communicates over a medium selected from the group consisting of fiber optic cable, radio frequency, wireless, infrared (IR), and category 5 cable.

10. The system of claim 1 in which the analysis system is located remotely from the at least one sensor.

11. The system of claim 10 in which the analysis system comprises at least one computer running software algorithms to perform the processing of the real time digital images and generating of control outputs.

12. The system of claim 11 in which the at least one computer communicates with the broadband communication network via a switch.

13. The system of claim 1 in which the analysis system includes a human machine interface for displaying control and alarm information to an operator.

14. The system of claim 13 in which the human machine interface comprises at least one computer with a display for displaying digital images from the at least one sensor as a real time video stream.

15. The system of claim 14 in which the computer display displays multiple video streams simultaneously.

16. The system of claim 14 in which the real time video stream is generated using decimated images from the at least one sensor to optimize bandwidth.

17. The system of claim 16 in which the decimated images are one quarter or one eighth resolution images.

18. The system of claim 16 in which decimation of the images is performed at the at least one sensor.

19. The system of claim 16 in which decimation of the images is performed by the analysis system.

20. The system of claim 14 in which the real time video stream comprises uncompressed images.

21. The system as claimed in claim 10 in which the analysis system comprises a processing unit associated with the at least one sensor.

22. The system of claim 1 in which the analysis system includes means for remotely setting image acquisition and image stream rates for the at least one sensor, such that the loading of the broadband communication network is dynamically allocatable to any one of the at least one sensor.

23. A method for monitoring and controlling a manufacturing process of a web product occurring on manufacturing equipment comprising:
acquiring real time digital images of the web product and the equipment using at least one sensor positioned at a pre-determined location adjacent the manufacturing equipment;
transferring the real time digital images from the at least one sensor via a broadband communication network to an analysis system;
processing the real time digital images using the analysis system and generating control outputs for communication to the manufacturing equipment by the broadband communication network.
